(19) United States
(12) Patent Application Publication
(10) Pub. No.: US 2003/0099218 A1
(43) Pub. Date: May 29, 2003

(54) Apparatus and method for improving noise tolerance of TDMA links

(76) Inventor: Brian Jay Tillotson, Kent, WA (US)

Correspondence Address: Harness, Dickey & Pierce, P.L.C., P.O. Box 828, Bloomfield Hills, MI, 48303, US

(21) Appl. No.: 09/998,556

(22) Filed: Nov. 29, 2001

(51) Int. Cl. H04B 7/212; H04J 3/00

(52) U.S. Cl. 370/337; 370/347; 370/442

(57) ABSTRACT

A method for reducing a signal-to-noise ratio requirement in a time division multiple access (TDMA) link of a mobile network. The network includes a first node and a second node. The method includes receiving at the first node, an initial TDMA signal burst transmitted from the second node, and determining link state variables, thereby synchronizing the first node to the TDMA signal burst. The method further includes tracking the link state variables between the initial TDMA signal burst and subsequent receptions of TDMA signal bursts from the second node at the first node.

### FIELD OF INVENTION

The invention relates generally to mobile networks and more particularly to reducing the signal-to-noise ratio (SNR) in a time division multiple access (TDMA) link of the mobile network to achieve a given data rate.

### BACKGROUND OF THE INVENTION

Initiating an RF data link in a mobile network requires a period during which a receiving node locks onto, or synchronizes, with the incoming signal. For example, when forming a link between two mobile network nodes, such as a receiving node A and a transmitting node B, the nodes negotiate a link having a certain frequency band, modulation, and data rate prior to node A receiving RF energy from node B. Thus, before A can interpret the incoming RF energy as data, it must estimate signal characteristic values, such as frequency, carrier phase, amplitude, symbol phase, and word phase, collectively referred to as link state variables. As used herein, a node is any point in the mobile network capable of receiving a signal, or transmitting a signal, or both, such as a satellite, an aircraft, a ground station, or a radio.

To correctly synchronize with the signal, or estimate the link state variables, node A must perform various steps. One step is to estimate the frequency at which the signal arrives. Although the frequency band has been determined, there will be a Doppler shift due to relative motion of the nodes and a frequency offset due to differences in their frequency generators. Therefore, node A's modem must scan a range of frequencies to find a sufficiently precise match. Another step is to estimate the phase of the incoming carrier wave. Initially, the phase of A's reference may be up to 180 degrees out of phase with B's arriving carrier. Node A then scans over all phase shifts to find a sufficiently precise phase match.

Yet another step is to estimate the amplitude if an amplitude-encoded modulation such as QAM is used. This step is not usually implemented as a scan over all amplitudes, but it does require time for the amplitude measurement to settle. If a phase-only modulation such as QPSK is used, then the amplitude estimate can be much less precise. Further steps are to estimate the phase of bit, or symbol, synchronization, and to identify the phase of word synchronization.

To facilitate the synchronization steps, node B initially transmits a sequence of symbols, referred to as a preamble. Node A utilizes the preamble to perform the synchronization steps. Once all the synchronization steps are complete, node B can vary its transmission to indicate data in the form of ones and zeroes. Node A identifies the incoming data by changes in phase, and amplitude, from the synchronized reference signal.

For a ‘Synchronous’ link, or a link that remains active all the time after it is formed, this synchronization need only be performed once. After node A achieves a lock on the signal, it continuously adjusts the frequency, phase and amplitude of its reference signal to track the incoming signal from node B. Because the synchronization only happens once for each long-lasting link, little efficiency is lost if the synchronization takes quite a long time. For example, ten seconds of synchronization time is a minor loss for a link that lasts ten minutes.

The situation is quite different for a link that uses time-division multiple access (TDMA). A TDMA link is implemented as a series of short RF bursts. For example, a typical TDMA burst duration in a planned military network is about 100 microseconds. In a conventional TDMA link, each incoming burst must go through a synchronization, as described above. Node B begins each burst with a preamble that enables node A to synchronize its reference signal to the incoming signal. If the preamble lasts as long as the whole burst, then no time is left to transmit data. To achieve reasonable efficiency, the synchronization period must last only a small fraction of the burst duration, such as about 5 percent of the burst.

This discrepancy between short and long synchronization periods imposes a signal-to-noise disadvantage on TDMA links. Synchronization is based on sampling the signal to estimate the link state variables. If the receiver takes only a short time to measure these values, there are few samples over which to average any noise, so the estimate varies substantially from sample to sample. If the receiver takes a long time to measure the values, random noise can be averaged out over many samples. This means the long synchronization period suppresses more noise, so the receiver can lock onto a signal that arrives with a lower signal to noise ratio (SNR). The consequence is that a typical TDMA link requires a higher SNR at the antenna than a synchronous link. In many cases, a TDMA link needs approximately four times better SNR than a synchronous link.

For networks that use directional antennas, this signal-to-noise disparity indicates that the angular separation between TDMA links must be greater than the angular separation between synchronous links. This reduces the primary advantage of point-and-shoot TDMA networks, which is the ability to form more links than a synchronous network.

Therefore, it would be desirable to provide a mobile network having a lower required SNR, wherein each burst of a TDMA link is synchronized at about the same SNR as a synchronous link. Said another way, it would be desirable to provide a mobile network that can tolerate signals having a lower SNR, or that the minimum SNR threshold at which the network will function is reduced. This would reduce the SNR needed to achieve high data rates using TDMA links and allow a TDMA network to form a much larger number of links than a synchronous network.

### BRIEF SUMMARY OF THE INVENTION

In one preferred form of the present invention a method is provided for reducing a required SNR in a TDMA link of a mobile network. The network includes a first node and a second node. The method includes receiving at the first node an initial TDMA signal burst transmitted from the second node, and determining link state variables, thereby synchronizing the first node to the TDMA signal burst. The method further includes tracking the link state variables between the initial TDMA signal burst and subsequent receptions of TDMA signal bursts from the second node at the first node.

In another embodiment a mobile network is provided for reducing required SNR in TDMA links. The network comprises a first node and a second node that transmits an initial TDMA signal burst to the first node. The first node receives the initial TDMA signal burst, and tracks link state variables between the initial TDMA signal burst and at least one subsequent reception of a TDMA signal burst transmitted from said second node.

In yet another embodiment, a method is provided for reducing a required SNR in a TDMA link of a mobile network. The network includes a first node and a second node. The method includes receiving at the first node, an initial TDMA signal burst from the second node, wherein the initial TDMA signal burst includes a long preamble. Additionally, the method includes utilizing the long preamble to determine link state variables, and storing the link state variables. Furthermore, the method includes receiving at the first node at least one subsequent TDMA signal burst from the second node having a short preamble, and updating the stored link state variables upon reception of the subsequent TDMA signal burst.

### BRIEF DESCRIPTION OF THE DRAWINGS

The present invention will become more fully understood from the detailed description and accompanying drawings, wherein;

FIG. 1 is a schematic of a system for tracking the frequency, amplitude, and various phases of an incoming signal between bursts on a given TDMA link within a mobile network, in accordance with a preferred embodiment of the present invention.

FIG. 2 is a graphical representation showing a signal burst having a reduced SNR requirement, as provided by the system shown in FIG. 1.

### DETAILED DESCRIPTION OF THE INVENTION

The following description of the preferred embodiments is merely exemplary in nature and is in no way intended to limit the invention, its application, or uses.

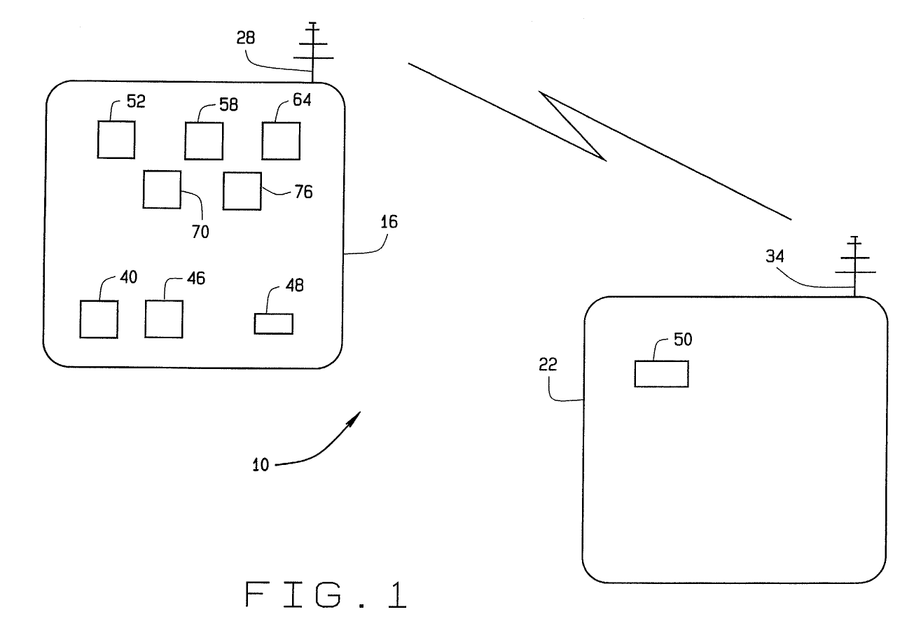

FIG. 1 is a schematic of a system 10 for tracking the frequency, amplitude, and various phases of an incoming signal between bursts on a given TDMA link, within a mobile network. System 10 includes, a first node 16 and a second node 22 which are points in the mobile network that are capable of transmitting an RF signal, or receiving an RF signal, or both. For example, a network node, such as first node 16 or second node 22, can be a satellite, a cell phone, a radio, a server located at a ground station, or a server located on a mobile platform, such as an aircraft, train, bus, or ship. First node 16 includes an RF antenna 28 and second node 22 includes an RF antenna 34. In the preferred embodiment, antennas 28 and 34 are directional RF antennas, such as phased array antennas (PAA). First node 16 further includes a processor 40 for executing all functions of first node 16, and an electronic data storage device 46 for storing information, data, and algorithms utilized by processor 40. In a preferred embodiment, system 10 is utilized in a PAA-based high-bandwidth mobile network.

As used herein second node 22 is described as a node for transmitting a signal, and first node 16 is described as a node for receiving the signal transmitted from second node 22. However, in an alternate embodiment both first node 16 and second node 22 are capable of transmitting and receiving signals in accordance with the invention. Additionally, although the invention is described in terms of two nodes, first node 16 and second node 22, it should be understood that in addition to first node 16, system 10 could include a plurality of second nodes 22, wherein some, or all, nodes transmit and/or receive signals between one or more nodes within system 10, in accordance the invention.

System 10 is applicable in TDMA networks, particularly high-bandwidth networks, in which the data rate along a single node-to-node backbone link is approximately 100 Mbits per second. In some instances, direct links between nodes may be as long as 900 km. To attain such high data rates at long ranges, directional antennas must be used, such as a PAA. PAAs provide some advantages, including the ability to hop a beam from target to target as rapidly as 10,000 times per second. Hopping the beam permits many links per antenna, but requires that each link use a TDMA protocol. In a typical TDMA network backbone each beam in the backbone is shared among only a few links. This indicates that the revisit interval for a given link is often only a few time slots long. System 10 is particularly beneficial for links with relatively short revisit intervals.

In the preferred embodiment, first node 16 and second node 22 each have an internal references 48 and 50, respectively, for frequency and phase, such as a crystal oscillator. When first node 16 establishes a TDMA link with second node 22, first node 16 fills in a data structure and stores the data structure in database 46. The data structure contains data pertaining to frequency, amplitude and phase information of the incoming signal. For example, the data structure contains at least one of a node identity that identifies which node is transmitting the signal burst, a nominal frequency of the incoming signal burst, an antenna pointing, or setting, that indicates the azimuth and elevation of the transmitting node, a frequency offset, a carrier phase, a signal amplitude, a symbol phase, and a word phase. Each element can be used with or without any other element such that different embodiments might use one, some, or all of these elements. The data structure filled in by first node 16 pertaining to the incoming signal only describes the half of the link that is received by first node 16. For the half of the link that is transmitted by first node 16, first node 16 has a different data structure.

In an alternated embodiment, wherein system 10 includes nodes in addition to first node 16 and second node 22, for example a third, forth and fifth node (not shown), for the receive portion of each link, first node 16 fills in a data structure for each node. In another alternate embodiment, first node 16 remembers the frequency, amplitude and phase information of the incoming signal using a physical oscillator for each link, where the oscillator is tuned during each burst to match the frequency and phase of the incoming RF signal burst.

Generally, a PAA based TDMA link is different from an omnidirectional TDMA link in that with an omnidirectional antenna, each node only needs to remember the time slots during which that node is authorized to transmit. During all other slots, the node listens to whatever arrives and doesn't need to know the source of a burst in order to receive the burst. The omnidirectional antenna will receive a burst from any direction, and if the burst is addressed to the listening node, the listening node retains the data.

In contrast, in a PAA based network, the receiving PAA, such as antenna 28, must be pointed in the correct direction to receive a burst. Each receiving node, such as first node 16, must remember what other nodes, such as second node 22, are authorized to send to the receiving node during every time slot so the receiving node can properly point its PAA. Therefore, each node maintains a data record for every time slot in a TDMA cycle. For example, in a typical TDMA sequence, the receiving node has a record of which link to address at each TDMA time slot. The following table shows the first fifteen receive slots of a typical TDMA cycle when the receiving node receives transmissions from a three transmitting nodes, identified by the letters B, C and D.

| | | | | | | | | | | | | | | | |
|---|---|---|---|---|---|---|---|---|---|---|---|---|---|---|---|
| Time Slot: | 1 | 2 | 3 | 4 | 5 | 6 | 7 | 8 | 9 | 10 | 11 | 12 | 13 | 14 | 15 |
| Link: | B | C | D | B | C | D | B | C | D | B | C | D | B | C | D |

The receiving node adjusts its directional antenna such that the receive beam is pointed at each node in the TDMA cycle during the appropriate slots. For example, at time slots 1, 4, 7, 10, and 13, the receiving node uses the azimuth and elevation of the node B to point the antenna directly at the node B. The receiving node then sets its receive frequency to the transmit frequency of the transmitting node and waits for a burst from the transmitting node to arrive. When the burst arrives, the receiving node uses the preamble to synchronize with the incoming signal, and then demodulates the signal.

Referring to FIG. 1, after first node 16 and second node 22 negotiate a link, second node 22 transmits an initial signal to first node 16 in time slot one that contains a long preamble. First node 16 utilizes the long preamble to determine the link state variables of the incoming signal. To determine the frequency offset link state variable, first node 16 uses the long preamble to scan over a frequency offset range, such as frequencies having the value of a nominal frequency plus or minus a maximum margin allowed for Doppler and timing differences. To determine the signal amplitude link state variable, first node 16 uses the long preamble to narrow down the amplitude estimate from the full allowable dynamic range to a close approximation of the true amplitude. To determine the carrier phase, the symbol phase, and the word phase link state variables, first node 16 uses the long preamble to scan over carrier phase offsets ranging from −180° to +180°, scan over symbol phase offsets ranging from −180° to +180°, and scan over word phase offsets ranging from −180° to +180°. Thus, at the end of the initial burst, first node 16 is synchronized to the incoming signal, thereby having a precise measure of the link state variables. First node 16 then stores the link state variable values in the data structure for the link with second node 22.

In a conventional TDMA burst, the preamble is about one twentieth of the burst, i.e. approximately 128 bits long. In contrast, the long preamble sent by second node 22 in the initial signal burst to first node 16 is many times longer than a typical preamble. For instance, the long preamble may be 500 bits, 1000 bits, or as long as the entire burst, thereby enabling first node 16 to use several times as many samples to estimate the link characteristics, which provides much greater noise rejection.

At time slot two, first node 16 receives a signal burst from another transmitting node similar to second node 22, and at slot three, first node 16 receives a signal burst from yet another transmitting node similar to second node 22. Thereafter, at time slot 4, first node 16 fetches, or retrieves, the stored link state variables for the link with second node 22. First node 16 uses the frequency offset value to load a starting point into a frequency estimator 52, the signal amplitude value to load a starting point into an amplitude estimator 58, the carrier phase to load a starting point into a carrier phase estimator 64, the symbol phase to load a starting point into a symbol phase estimator 70, and the word phase to load a starting point into a word phase estimator 76.

The frequency estimator 52, amplitude estimator 58, carrier phase estimator 64, symbol phase estimator 70 and word phase estimator 76 can be implemented as hardware, or as software having some hardware components. For example, amplitude estimator 58 can obtain an amplitude measurement of the incoming signal burst using an analog to digital converter, or amplitude estimator 58 can obtain an amplitude measurement using an algorithm that backs off on the gain until the amplitude coming out of an amplifier is below some predetermined threshold. Phase estimator 70 can directly measure the phase by utilizing phase shifting electronics hardware to shift the phase of the signal until a zero crossing is obtained within a certain time interval, or by digitizing the signal and applying a Fourier transform algorithm.

The signal burst from second node 22 in time slot four contains a short preamble. When the burst reaches first node 16, processor 40 utilizes frequency estimator 52, amplitude estimator 58, carrier phase estimator 64, symbol phase estimator 70, and word phase estimator 76 to interpret the short preamble thereby precisely estimating frequency, amplitude, and the various phases of the signal burst. Thus, since the link state variables determined based on the long preamble transmitted in slot one are stored in database 46, processor 40 begins synchronizing with the signal burst from second node 22 during time slot four having very good predetermined initial estimates of the frequency, amplitude and various phases of the incoming signal.

Having the predetermined link state variables allows first node 16 to lock on, or synchronize with, the signal burst from second node 22 in the same amount of time as a conventional TDMA links, but having better immunity to noise. Alternatively, the stored link state variables allow first node 16 to synchronize in less time than a conventional TDMA link, but with no better immunity to noise. After first node 16 has locked on to the signal burst at time slot four, the short preamble ends and first node 16 demodulates the remainder of the burst. At the end of the burst, first node 16 stores its new link state variables in the data structure for the link from second node 22, which are then used as the predetermined link state variables for a signal burst from second node 22 having a short preamble, during time slot seven.

At time slot seven, first node 16 again handles the link to second node 22. This time, processor 40 fetches the link state variable values that were stored at the end of slot four. It uses these stored values as starting points for estimating frequency, amplitude, and phase data for the burst arriving in slot seven. Processor 40 then updates the link state variable values and stores them in the data structure for second node 22 for use with the next burst from second node 22.

Thus, after each subsequent signal burst received from second node 22, first node 16 updates the link state variables, stores the updated link state variables in the data structure for second node 22, and utilizes the stored updated link state variables to synchronize with a subsequent signal burst from second node 22 with a greatly reduced SNR requirement. The reduced SNR requirement allows network 10 to achieve high data rates using TDMA links. It will be appreciated that, as used herein, the term SNR requirement, or required SNR, means a predetermined SNR that network 10 can tolerate and continue to function properly, or said another way, a minimum SNR threshold at which network 10 will function.

Generally, in a conventional TDMA implementation the link state information is not stored, or saved, after every burst. Therefore, the SNR requirement for a conventional TDMA link is constrained by the need to synchronize every burst using a relatively short preamble without having a predetermined estimate of the link state variables. System 10 provides a TDMA network where a transmitting node, such as second node 22, transmits an initial signal burst having a long initial preamble to allow the receiving node, such as first node 16, to synchronize with good noise resistance, then retain the link state information between bursts. This allows the receiving node to synchronize to each subsequent burst quickly with good noise resistance. The result is a TDMA link that operates with a substantially lower SNR requirement.

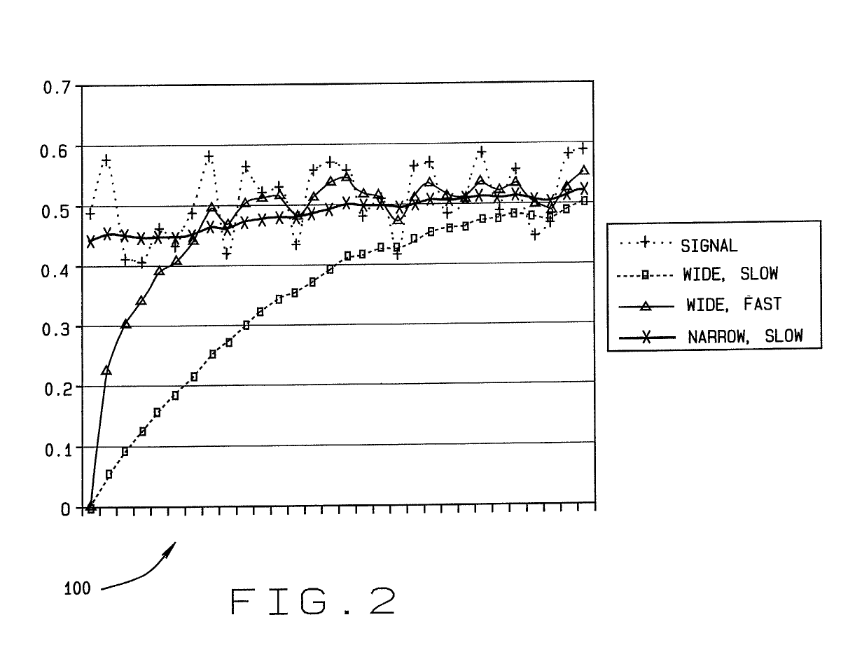

FIG. 2 is a graphical representation 100 showing a signal burst having a reduced SNR, as provided by system 10 shown in FIG. 1. More specifically, graphical representation 100 shows different approaches for estimating an arbitrary link state variable, such as amplitude, in the presence of noise, compared to the link state variable estimated utilizing system 10. As described above, system 10 allows a TDMA link to operate with a worse SNR than a conventional TDMA link. In FIG. 2, the arbitrary link state variable plus noise is represented by the line labeled “signal”. The labels on the other lines indicate a wide or narrow range of estimation (i.e. poor or good starting points) and a fast or slow rate of convergence. The x-axis in FIG. 2 indicates time in micro-seconds of a high-rate network, while the y-axis indicates unit of measure associated with the respective arbitrary link variable, for instance, if the variable is amplitude, the units of measure for the y-axis are volts.

The line labeled “Wide, Slow” represents the approach used in known synchronous links. The initial estimate is far from the actual value and convergence on the correct value is slow, but once the estimate has converged it does not vary greatly in response to noise. The line labeled “Wide, Fast” represents a known conventional TDMA link. The initial estimate of link state is far from the actual value, but convergence is fast. However, the same properties that allow for fast convergence mean that the estimate is not very robust against noise. Therefore, the estimate varies substantially from sample to sample. The line labeled “Narrow, Slow” represents an estimate of the link state variable utilizing system 10. The time constant for convergence is long, approximately the same as for the synchronous approach, but because the initial estimate is close to the actual value, convergence to the correct value is fast. The estimate is stable despite noise because it uses a long time constant. This stability is the basis for the reduced SNR requirement provided by system 10.

Referring to FIG. 1, as described above, the initial signal burst of a transmitting node in system 10, such as second node 22, contains a long preamble. However, the long preamble used in the initial burst may be transmitted again in four instances. A first instance is when the interval between bursts from second node 22 to first node 16 exceeds a predetermined threshold Δtₘₐₓ_{_{—}}_{gap}. This threshold is chosen so that the probability of successful lock-on, or synchronization, is acceptably high for intervals shorter than the threshold, for example, the likelihood of change in link characteristics over Δtₘₐₓ_{_{—}}_{gap} is small enough that first node 16 can still lock on. When the interval between bursts exceeds Δtₘₐₓ_{gap}, first node 16 has a poor chance of correctly estimating the link parameters using only the short preamble transmitted by second node 22 in a burst subsequent to the initial burst containing a long preamble. If the time between bursts exceeds Δtₘₐₓ_{_{—}}_{gap}, second node 22 uses the first burst after Δtₘₐₓ_{_{—}}_{gap} to transmit a long preamble. It is envisioned that TDMA slots will be assigned to avoid or minimize intervals that exceed the threshold Δtₘₐₓ_{_{—}}_{gap}.

A second instance of transmitting a signal burst containing a long preamble subsequent to the initial burst is when second node 16 changes the PAA used to send the signal, or when first node 22 changes the PAA uses to receive the signal. Changing PAAs is necessary at times because each PAA has a limited field of regard. For example, first node 16 might use a forward-looking PAA to receive signal bursts from second node 22 when the link is formed, but later use a port side PAA to receive signal burst from second node 22 when the mobile platform on which first node 16 resides changes direction. Typically, PAAs are mounted far enough apart that switching from one to the other will change the carrier phase by much more than one wavelength, so it will be necessary to resynchronize if carrier phase is tracked from burst to burst.

A third instance of transmitting a signal burst containing a long preamble subsequent to the initial burst is when the link is interrupted, for example by jamming, long enough such that the stored values are no longer valid. In such a case, first node 16 cannot correctly estimate the link state variables using only the short preamble. First node 16 must notify second node 22 that the link was interrupted. Second node 22 then transmits the long preamble in its next burst to first node 16 such that first node 16 can re-acquire the link state.

A fourth instance of transmitting a signal burst containing a long preamble subsequent to the initial burst is when second node 22 retransmits the long preamble at fixed intervals. In this approach, when synchronization is lost, all subsequent bursts are lost until the next long preamble is sent. For some applications, this is acceptable or even preferable if the interval between long preambles is chosen judiciously. Streaming video is an example of such an application.

As described above, system 10 tracks the carrier phase and other link state variables such as the nominal frequency, the antenna pointing, the frequency offset, the signal amplitude, the symbol phase, and the word phase, between signal bursts. However, it is envisioned that in an alternate embodiment system 10 will operate without tracking the carrier phase. More specifically, it will be appreciated that system 10 will operate in accordance with the present invention if only the frequency, amplitude, and symbol phase need to be tracked.

Nonetheless, in the preferred embodiment, system 10 tracks the carrier phase between bursts for links in the backbone of planned PAA based networks. PAA based networks use burst durations of about 100 microseconds, and in the network backbone the interval between bursts on a single link is typically about one millisecond. At the end of any signal burst from second node 22, first node 16, has an accurate estimate of frequency and carrier phase. If the mobile platforms on which first node 16 and second node 22 reside each continue moving straight at constant relative radial velocity, when the next burst starts, there will be no change in Doppler and therefore no change in frequency. Additionally, phase is measured relative to a zero-crossing point of the reference signal, so if frequency has not changed then the reference signal will still be correct and the phase relative to that reference will be unchanged.

However, it is more realistic that neither node will follow a constant velocity vector and each node will change its velocity vector by changing the speed or path of the mobile platform on which the node resides. For example, if the maximum acceleration of a mobile platform is 10 gravities, and first node 16 accelerates toward second node 22 at the maximum acceleration for the full interval between bursts, or about one millisecond for a network backbone link, there will be a change in frequency and a change in phase of the received signal. The error between the stored phase value and the actual value is calculated as follows:

Δₘₐₓx=aₘₐₓ(Δtₘₐₓ_{_{—}}_{gap})²/2=100×0.001²/2=5.0E−5 m (i.e. 50 microns);

and

Δₘₐₓφ=2πΔₘₐₓx/λ=2π5.0E−5/0.02=0.0157 radian (i.e. 0.9 degrees);

wherein,

Δtₘₐₓ_{_{—}}_{gap}=maximum interval between burst on a given link,

aₘₐₓ=maximum acceleration a PAA on a node will experience,

Δₘₐₓx=maximum change in radial distance from straight path after Δtₘₐₓ_{_{—}}_{gap},

Δₘₐₓφ=maximum error in estimated carrier phase after Δtₘₐₓ_{gap}, and λ=nominal wavelength.

Therefore, the acceleration induces a change in carrier phase of less than one degree. When first node 16 receives the next burst from second node 16, it uses the stored phase value as a starting point for estimating the carrier phase. A starting point within one degree of the correct value is close enough to allow first node 16 to quickly converge on the correct value.

The acceleration of first node 16 toward second node 22 also induces a change in frequency of the signal burst. The error between the stored frequency and the actual frequency is calculated as follows:

Δₘₐₓv=aₘₐₓΔtₘₐₓ_{_{—}}_{gap}=100×0.001=0.1 m/s;

and

Δₘₐₓf=fΔₘₐₓv/c=15E9×0.1/3E8=5 Hz,

wherein,

Δₘₐₓv=maximum change in radial velocity after Δtₘₐₓ_{_{—}}_{gap},

Δₘₐₓf=maximum error in estimated frequency after Δtₘₐₓ_{_{—}}_{gap},

f=nominal frequency, and

c=speed of light.

Thus, when first node 16 accelerates toward second node 22 at an acceleration rate of 10 gravities, signal bursts from second node 22 to first node 16 have a frequency change of 5 Hz. This is small enough such that first node 16 can quickly converge on the correct value.

If the frequency was not tracked between bursts, the range of frequencies first node 16 would have to scan would be much larger, for example:

Δf=2fvₘₐₓ/c=2×15E9×1000/3E8=100 kHz

Therefore, first node 16 would require substantially more time to accurately synchronize with signal bursts from second node 22, if it had to accommodate such a wide frequency range.

In an alternate embodiment, system 10 is utilized in a network having earth-to-satellite links. TDMA is commonly used to allow a large number of ground stations to access a single GEO satellite. System 10 allows those earth-to-satellite links to operate in a harsher noise environment, thereby allowing satellites within the network to be spaced more closely along the GEO belt.

While the invention has been described in terms of various specific embodiments, those skilled in the art will recognize that the invention can be practiced with modification within the spirit and scope of the claims.

What is claimed is:

1. A method for reducing a required signal-to-noise ratio in a time division multiple access (TDMA) link of a mobile network, the network including a first node and a second node, the method comprising:
receiving at the first node an initial TDMA signal burst from the second node;
determining link state variables, thereby synchronizing the first node to the initial TDMA signal burst; and
tracking the link state variables between the initial TDMA signal burst and subsequent receptions of TDMA signal bursts from the second node at the first node.

2. The method of claim 1 wherein receiving an initial TDMA signal burst comprises receiving a long preamble included in the initial TDMA signal burst.

3. The method of claim 1 wherein determining link state variables comprises utilizing the long preamble to determine at least one of a frequency offset from a nominal frequency, a carrier phase, a signal amplitude, a symbol phase, and a word phase.

4. The method of claim 1 wherein tracking the link state variables comprises:
storing the link state variables; and
receiving at the first node at least one subsequent TDMA signal burst from the second node, the subsequent TDMA signal burst including a short preamble.

5. The method of claim 4 wherein tracking the link state variables further comprises:
fetching the stored link state variables; and
updating the link state variables utilizing the short preamble, thereby synchronizing the first node to the subsequent TDMA signal burst.

6. The method of claim 5 wherein tracking the link state variables further comprises storing the updated link state variables.

7. A system for providing a reduced signal-to-noise ratio requirement in time division multiple access (TDMA) links, within a mobile network, said system comprising:
a first node; and
a second node configured to transmit an initial TDMA signal burst to said first node, and wherein said first node configured to:
receive the initial TDMA signal burst; and
track link state variables between the initial TDMA signal burst and at least one subsequent reception of a TDMA signal burst transmitted from said second node.

8. The system of claim 7 wherein the initial TDMA signal burst includes a long preamble, said first node further configured to determine said link state variables using the long preamble, thereby synchronizing said first node to the initial TDMA signal burst.

9. The system of claim 7 wherein said link state variables comprise at least one of a frequency offset from a nominal frequency, a carrier phase, a signal amplitude, a symbol phase, and a word phase.

10. The system of claim 7 wherein to track said link state variables, said first node is further configured to:
store said link state variables; and
receive at said first node at least one subsequent TDMA signal burst from said second node, the subsequent TDMA signal burst including a short preamble.

11. The system of claim 10 wherein to track said link state variables, said first node is further configured to:
retrieve said stored link state variables; and
update said link state variables utilizing the short preamble, thereby synchronizing said first node to the subsequent TDMA signal burst.

12. The system of claim 11 wherein to track said link state variables, said first node is further configured to store said updated link state variables.

13. A method for reducing a signal-to-noise ratio requirement in a time division multiple access (TDMA) link of a mobile network, the network including a first node and a second node, the method comprising:
receiving at the first node an initial TDMA signal burst from the second node, the initial TDMA signal burst including a long preamble;
utilizing the long preamble to determining link state variables;
storing the link state variables;
receiving at the first node at least one subsequent TDMA signal burst from the second node, the subsequent TDMA signal burst including a short preamble; and
updating the stored link state variables upon reception of the subsequent TDMA signal burst.

14. The method of claim 13 wherein utilizing the long preamble to determine link state variables comprises utilizing the long preamble to determine at least one of a frequency offset from a nominal frequency, a carrier phase, a signal amplitude, a symbol phase, and a word phase.

15. The method of claim 13 wherein updating the retained link state variables comprises:
retrieving the stored link state variables; and
updating the link state variables utilizing the short preamble.

16. The method of claim 15 wherein updating the retained link state variables further comprises storing the updated link state variables.
